(19) United States
(12) Patent Application Publication
(10) Pub. No.: US 2013/0203033 A1
(43) Pub. Date: Aug. 8, 2013

(54) EDUCATIONAL GAMING DEVICE FOR LEARNING EVOLUTIONISM

(71) Applicants: Meng-Tzu Cheng, Yilan County (TW); Yu-Wen Lin, Nantou County (TW); Hsiao-Ching She, Hsinchu City (TW)

(72) Inventors: Meng-Tzu Cheng, Yilan County (TW); Yu-Wen Lin, Nantou County (TW); Hsiao-Ching She, Hsinchu City (TW)

(21) Appl. No.: 13/440,795

(22) Filed: Apr. 5, 2012

(30) Foreign Application Priority Data
Feb. 7, 2012 (TW) 101103922

(51) Int. Cl. G09B 23/00

(52) U.S. Cl. 434/276

(57) ABSTRACT

An educational gaming device for learning evolutionism comprises a display device, a storage device and an operation unit. The storage device stores at least one scene and a plurality of corresponding representative creatures. The storage device and the display device are coupled to the operation unit. The operation unit selects at least two creatures from the representative creatures to respectively function as at least one player character and at least one non-player character. The operation unit drives the display device to show the process of interactivity and evolution of the player character and the non-player character in the scene. The game of the present invention features clear rules, instant feedbacks and competitions, and has much more interaction with the users than common instructional activities or common educational animations.

### BACKGROUND OF THE INVENTION

1. Field of the Invention

The present invention relates to a gaming device, particularly to an educational gaming device for learning evolutionism.

2. Description of the Related Art

Evolution refers to any changes across successive generations in heritable characteristics of a biological population. Herein, the heritable characteristics are referred to as gene expressions. Genes are reproduced and passed onto the next generation. Genetic mutation causes variation of heritable characteristics and diversity of individuals. These new characteristics may pass to other populations via horizontal gene transfer or population immigration. While the genetic variation becomes popular or rare because of non-random natural selection or random genetic drift, evolution occurs.

At present, the concept of evolutionism is mainly taught in classrooms. However, the learners often find it hard to grasp the abstract, dynamic and successive evolutional variations, or imagine the living environment of extinct creatures and the ways these extinct creatures adapted themselves to the environment from classroom instructions. Thus learners have difficulty constructing the concepts and easily lose interest. In such cases, learners are less likely to achieve their expected goal. As to the conventional educational systems, a Taiwan patent No. I224761 disclosed a realtime multi-user online mathematical learning system, which is mainly a mathematical item bank system providing exercises and even contests for learners. However, the system is unable to help the learners establish new concepts. The system is primarily for exercise and review. The system is hard to help learners without the related concepts or with low achievement.

A Taiwan patent No. I276017 disclosed an automatic interactive computer instruction system, which is mainly used to play video. Although users can use buttons to undertake simple operations, they can only passively receive information in most situations. Therefore, the system lacks sufficient interaction. The videos do not provide competitions, clear targets, and instant feedbacks, which are normally provided by games to inspire intrinsic motive. Therefore, the system cannot attract users to devote themselves to the lessons of the video.

A Taiwan patent No. I445437 disclosed an interactive animation instruction method and system. Refer to FIG. 1. The system comprises an animation item database 10, a topic database 12, a selection-receiving module 14 and an animation supply module 16. The animation item database 10 records at least one animation item. The topic database 12 records at least one piece of topic data. The topic data includes a piece of topic-related animation data. The topic-related animation data contains the configuration setting values of the animation items in the topic data. The selection-receiving module 14 receives the animation items and topics selected by the user, according to the animation items and topic selected by the user and the configuration setting values of the animation items, the animation supply module 16 integrates the corresponding animation items in the animation item database 10 and the corresponding topic data in the topic database 12 to provide an animation of the topic for the user. Although the prior art is titled the interactive animation instruction system, users also can only passively receive information in most situations. The interaction of the system is less than that of a game. Even though the system also provides exercises, it is hard to attract users to devote themselves to learning.

Accordingly, the present invention proposes an educational gaming device for learning evolutionism to solve the abovementioned problems.

### SUMMARY OF THE INVENTION

The primary objective of the present invention is to provide an educational gaming device for learning evolutionism, wherein the evolutionism-related concepts are incorporated in the rules and process of the game, and the Mesozoic Era and the Cenozoic Era are used as the scenes of the game with representative creatures of the above-mentioned eras used as the characters of the game. The user learns the natural selection mechanism through the struggle-for-existence process of the player characters and the non-player characters as well as the origin and development of life. The features of the creatures appearing in each era and the environment to which the creatures have to adapt to, helps promote interest and achievement of leaning, thus assisting the user to naturally learn the concepts of evolutionism in the game.

To realize the abovementioned objective, the present invention proposes an educational gaming device for learning evolutionism, which comprises a display device, a storage device and an operation unit. The storage device stores two scenes and a plurality of representative creatures corresponding to the scenes. The scenes include the Mesozoic Era and the Cenozoic Era. The storage device and the display device are connected with the operation unit. The operation unit selects at least two creatures from the representative creatures to function as at least one player character and at least one non-player character. The operation unit shows on the display device the interaction and evolution of the player character and the non-player character. In the Mesozoic Era, the victory condition is that all the non-player characters have to die and the Archaeopteryx and the Eomaia have to appear and survive. In the Cenozoic Era, the victory condition is that all the non-player characters have to die and the Dryopithecus and the Australopithecus have to appear and survive.

Below, the embodiments are described in details in cooperation with the attached drawings to make it easier to understand the technical contents, characteristics, and accomplishments of the present invention.

### BRIEF DESCRIPTION OF THE DRAWINGS

FIG. 1 is a block diagram schematically showing the system of a conventional technology;

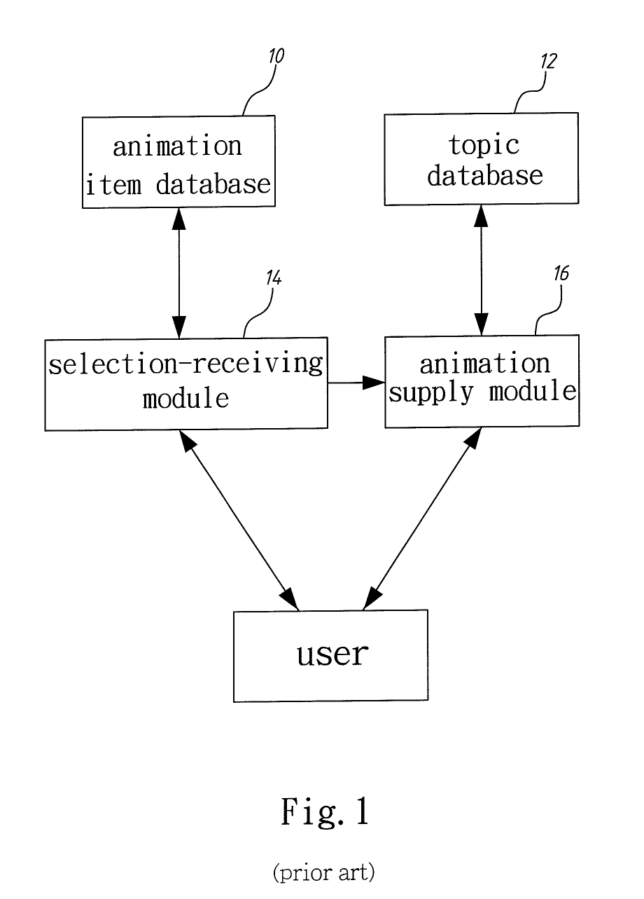

FIG. 2 is a block diagram schematically showing an educational gaming device for learning evolutionism according to one embodiment of the present invention;

FIG. 3 schematically shows that a display device presents various reptiles according to one embodiment of the present invention;

FIG. 4 schematically shows that a display device presents resource zones according to one embodiment of the present invention;

FIG. 5 schematically shows that a display device presents occupation of a resource zone according to one embodiment of the present invention;

FIG. 6 schematically shows that a display device presents a volcanic eruption according to one embodiment of the present invention;

FIG. 7 schematically shows that a display device presents a giant meteorite impact according to one embodiment of the present invention;

FIG. 8 schematically shows that a display device presents a fight according to one embodiment of the present invention; and

FIG. 9 schematically shows that a display device presents summoning of decomposers according to one embodiment of the present invention.

### DETAILED DESCRIPTION OF THE INVENTION

The present invention incorporates the concepts of evolutionism in the rules and process of the game, exempted from the conventional instruction model that the students receive information from the teacher passively. The game of the present invention features clear rules, instant feedbacks and competitions, and has much more interaction with the users than common instruction activities or common educational animations. The present invention enables the users to escape from being a passive information receiver and makes them an active participant and a concept constructor. The present invention embeds education in amusement and effectively promotes the interest and achievement of learning. The below is a description of the game's rules and the hardware operations of the present invention.

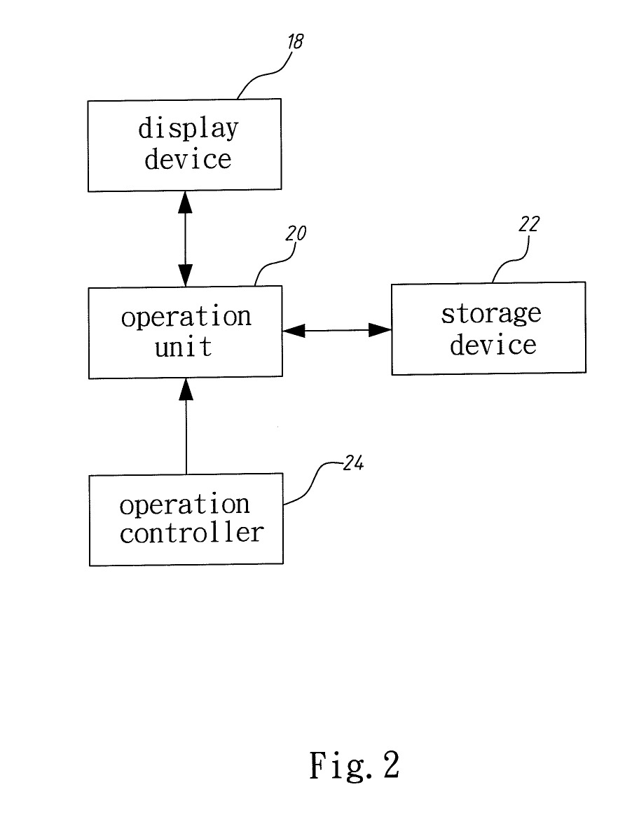

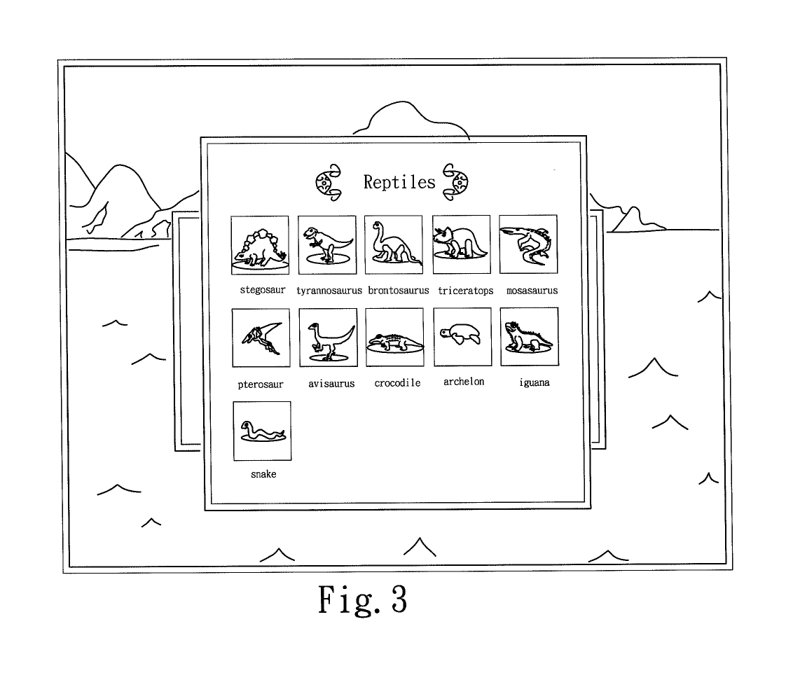

Refer to FIGS. 2-9. The educational gaming device for learning evolutionism of the present invention comprises a display device 18, a storage device 20 and an operation unit 22. The storage device 20 stores at least two scenes and a plurality of representative creatures corresponding to the scenes. In this embodiment, the storage device 20 stores two scenes, including the Mesozoic Era and the Cenozoic Era. The display device 18 and the storage device 20 are connected with the operation unit 22. As shown in FIG. 3, the operation unit 22 retrieves representative creatures from the storage device 20 and presents the representative creatures on the display device 18. The representative creatures stored in the storage device 20 include reptiles, such as a stegosaur, a tyrannosaurus, a brontosaurus, a triceratops, a mosasaurus, a pterosaur, an avisaurus, a crocodile, an archelon, an iguana and a snake. The operation unit 22 selects at least two representative creatures to respectively function as a player character and a non-player character. Then, the operation unit 22 presents on the display device 18 the interaction and evolutionary process of the player character and the non-player character in the scene. The operation unit 22 is connected with an operation controller 24 and presents corresponding actions according to the instructions of the operation controller 24.

The operation unit 22 presents on the display device 18 the operating interface of the player-character creatures, which includes functions of movement, occupation, attack, rest, reproduction, summoning, renourishment and status. The storage device 20 stores the following parameters and attributes for each representative creature: a required quantity parameter, a survival parameter, an attack power parameter, a defense power parameter, a movement parameter, a body size parameter, a living environment attribute, an ecological status attribute, a symbiosis attribute, a mutation attribute, and a supplementary attribute, which are presented on the display device 18 by the operation unit 22. The living environment attribute refers to land, water or air where a representative creature lives. The ecological status attribute refers to phytophagous, polyphagous, or sarcophagous. The symbiosis attribute refers to the interaction of a representative creature with the practical environment. In the game, the operation unit 22 controls a representative creature to coexist with another representative creature or control the same representative creatures to cluster so as to enhance the attack power or defense power thereof. For example, a crab coexists with an actinia to enhance the attack power thereof. The supplementary attribute refers to a special ability of a representative creature. For example, an octopus can eject ink, and a snake can eject venom, allowing them an offensive or defensive advantage in a fight.

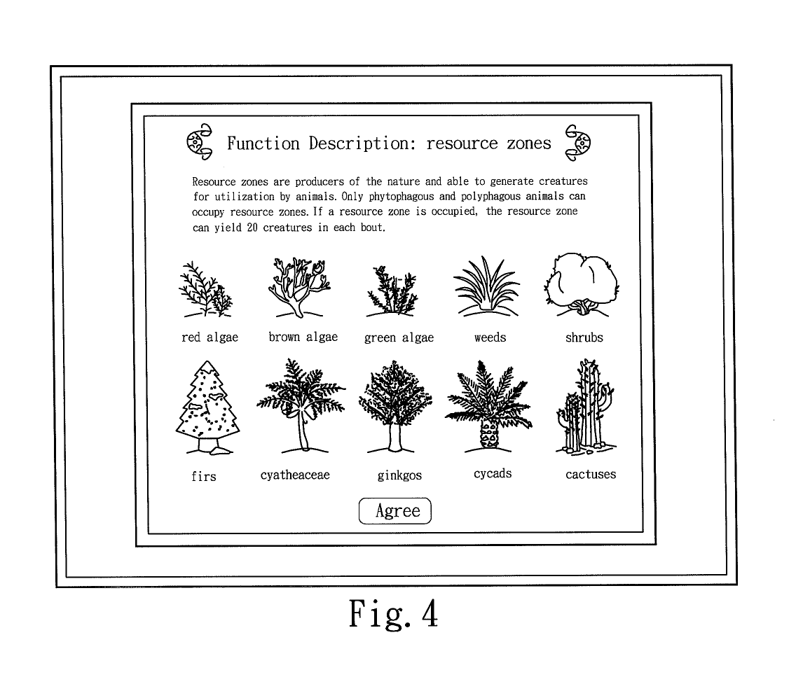

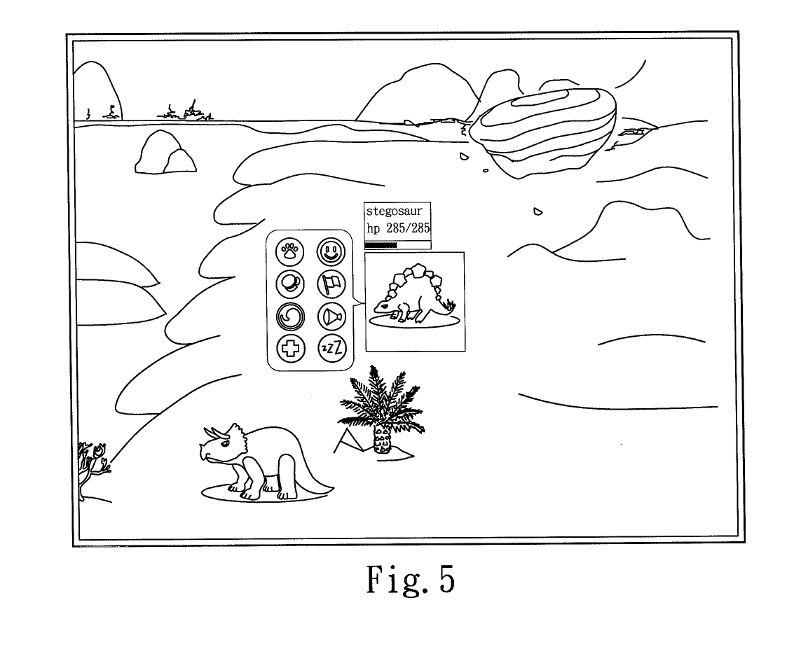

The operation unit 22 also presents on the display device 18 a plurality of resource zones, each of which can sustain a given quantity of creatures. As shown in FIG. 4, the resource zones include zones of red algae, brown algae, green algae, weeds, shrubs, firs, cyatheaceae, ginkgos, cycads, and cactuses. In the scene of the Mesozoic Era, the resource zones include zones of algae, mosses, ferns, and gymnosperms. In the scene of the Cenozoic Era, the resource zones include zones of algae, mosses, ferns, gymnosperms, and angiosperms. The operation unit 22 controls the player-character phytophagous animals or the player-character polyphagous animals to occupy the resource zones so as to increase the quantity of the player-character creatures. As shown in FIG. 5, a triceratops occupies a resource zone. When one resource zone yields creatures amounting to 20, which exactly satisfies the required quantity parameter for occupying the resource zone, the operation unit 22 is then instructed by the operation controller 24 to control the player-character creatures to reproduce or summon new species. When the player-character creatures reproduce, mutation would occur randomly. If the operation controller 24 does not send out any instructions, the operation unit 22 needn't undertake the abovementioned actions.

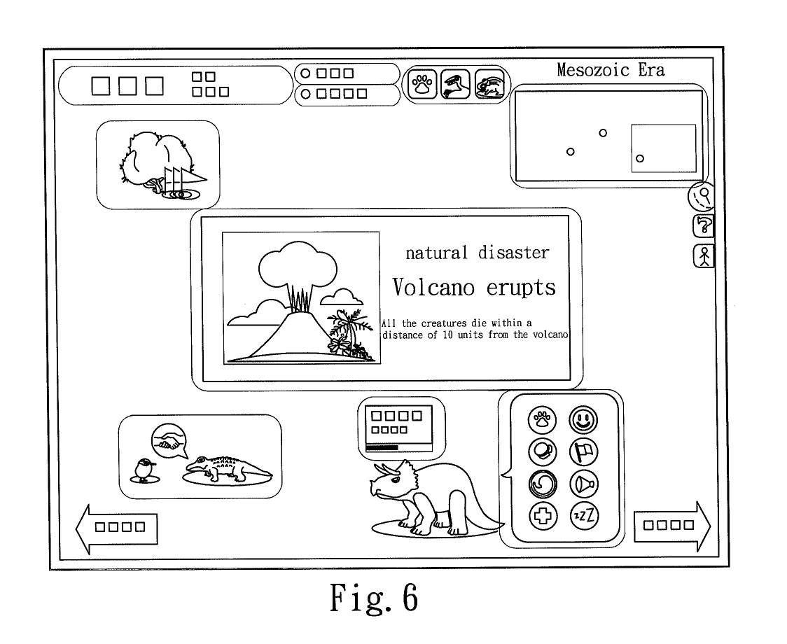

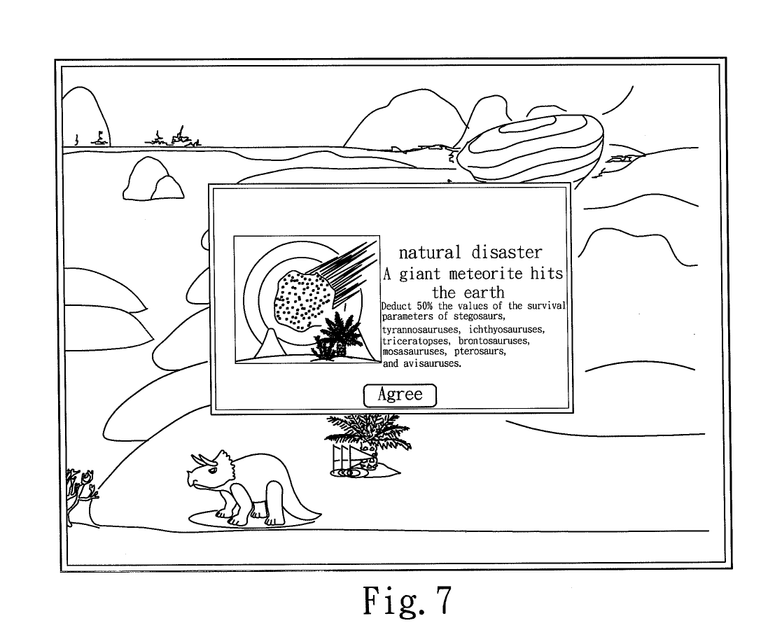

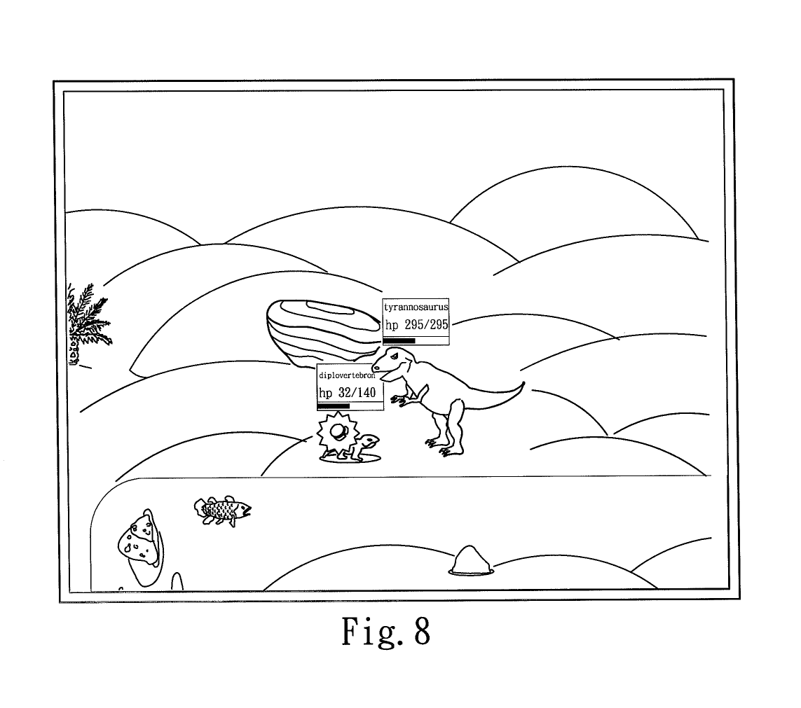

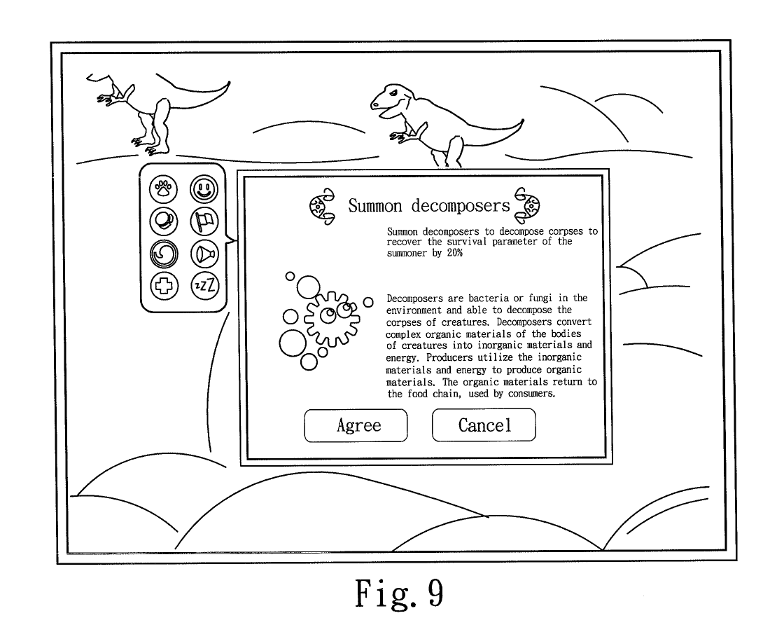

During the process of the game, a bout is defined to be a process whereby the player-character creature and the non-player-character creature are respectively moved by the operation unit 18 once. The operation unit 22 increases the quantity of the non-player-character creatures with increasing bouts and make responses to the locations where the player-character creatures and the non-player-character creatures respectively live. The operation unit 22 also increases natural disasters randomly with increasing bouts to govern the survival of the representative creatures or deduct the values of the survival parameters thereof. FIG. 6 and FIG. 7 respectively show the natural disasters of volcanic eruption and giant meteorite impact. When the player-character creature moved by the operation unit 22 on the display device 18 is attacked by the non-player-character creature, the operation unit 22 deducts the values of the survival parameters until the player or non-player character has zero value of the survival parameter, i.e. until the player or non-player character is dead. FIG. 8 shows that a diplovertebron fights with a tyrannosaurus. When a player-character creature dies in the scene, the operation unit 22 may be instructed by the operation controller 24 to control the surviving player-character creatures to summon decomposers in the environment, such as bacteria or fungi, to decompose the corpse of the player-character creature for renourishment, as shown in FIG. 9. Similarly, if the operation controller 24 does not send out any instruction, the operation unit 22 needn't undertake the abovementioned actions.

When the game starts, the operation unit 22 presents on the display device 18 a beginning animation introducing the birth of planet Earth, the appearance of the first cell, the environment of the Paleozoic era, and the creatures in existence at the time. Next, the operation unit 22 presents on the display device 18 the scene of the Mesozoic Era and the representative creatures retrieved from the storage device 20, whereby the player can select the player-character creatures and the non-player-character creatures. The player then uses the operation controller 24 to control the player-character creatures to undertake movement, occupation, rest, reproduction, summoning, mutation, evolution and renourishment in the scene of the Mesozoic Era and controls the player-character creatures to compete, interact and fight with the non-character creatures. The operation unit 22 also presents on the display device 18 the process that each representative creature is influenced by natural disasters. In the Mesozoic Era, the operation unit 22 sets the victory condition to be that all the non-player-character creatures have to die and the Archaeopteryx and the Eomaia have to appear and survive.

After the victory in the Mesozoic Era, the operation unit 22 presents on the display device 18 an interlude animation showing the causes of dinosaur extinction and the roles of the Archaeopteryx and the Eomaia in evolution. Next, the operation unit 22 presents the scene of the Cenozoic Era on the display device 18. The player then uses the operation controller 24 to control the player-character creatures to undertake movement, occupation, rest, reproduction, summoning, mutation, evolution and renourishment in the scene of the Cenozoic Era and controls the player-character creatures to compete, interact and fight with the non-character creatures. The operation unit 22 also presents on the display device 18 the process that each representative creature is influenced by natural disasters to enable the player to understand the natural selection mechanism. In the Cenozoic Era, the operation unit 22 sets the victory condition to be that all the non-player-character creatures have to die and the Dryopithecus and the Australopithecus have to appear and survive.

After the victory in the Cenozoic Era, the operation unit 22 presents on the display device 18 an ending animation showing the roles of the Dryopithecus and the Australopithecus in evolution and the appearance of civilization. Thus, the player has learned the concepts of evolutionism imperceptibly when the game is completely finished.

In conclusion, the present invention proposes an educational gaming device for learning evolutionism, which embeds education in entertainment to promote achievement of learners.

The embodiments described above are only to exemplify the present invention but not to limit the scope of the present invention. Any equivalent modification or variation according to the characteristics or spirit of the present invention is to be also included within the scope of the present invention.

What is claimed is:

1. An educational gaming device for learning evolutionism, comprising
a display device:
a storage device storing at least one scene and a plurality of representative creatures corresponding to said scene; and
an operation unit connected with said display device and said storage device, selecting at least two representative creatures from said plurality of representative creatures to respectively function as a player-character creature and a non-player-character creature, and presenting on said display device statuses of interaction and evolution of said player-character creature and said non-player-character creature.

2. The educational gaming device for learning evolutionism according to claim 1 further comprising an operation controller, wherein said operation unit receives instructions from said operation controller and presents actions corresponding to said instructions on said display device.

3. The educational gaming device for learning evolutionism according to claim 1, wherein said storage device stores two scenes, with said two scenes including a Mesozoic Era and a Cenozoic Era.

4. The educational gaming device for learning evolutionism according to claim 3, wherein before said Mesozoic Era, said operation unit presents on said display device a beginning animation including birth of the earth, appearance of a first cell, an environment of a Paleozoic era, and creatures in existence during said Paleozoic era.

5. The educational gaming device for learning evolutionism according to claim 3, wherein after said Mesozoic Era and before said Cenozoic Era, said operation unit presents on said display device an interlude animation including causes of dinosaur extinction and roles of an Archaeopteryx and an Eomaia in evolution.

6. The educational gaming device for learning evolutionism according to claim 3, wherein after said Cenozoic Era, said operation unit presents on said display device an ending animation including roles of a Dryopithecus and an Australopithecus in evolution and appearance of civilization.

7. The educational gaming device for learning evolutionism according to claim 3, wherein in said Mesozoic Era, said operation unit sets a victory condition to be that all said non-player-character creatures have to die and an Archaeopteryx and an Eomaia have to appear and survive.

8. The educational gaming device for learning evolutionism according to claim 3, wherein in said Cenozoic Era, said operation unit sets a victory condition to be that all said non-player-character creatures have to die and a Dryopithecus and an Australopithecus have to appear and survive.

9. The educational gaming device for learning evolutionism according to claim 1, wherein said operation unit presents on said display device a plurality of resource zones, each of which sustains a given quantity of said representative creatures.

10. The educational gaming device for learning evolutionism according to claim 9, wherein in said scene of a Mesozoic Era, said resource zones include zones of algae, mosses, ferns, and gymnosperms.

11. The educational gaming device for learning evolutionism according to claim 9, wherein in said scene of a Cenozoic Era, said resource zones include zones of algae, mosses, ferns, gymnosperms, and angiosperms.

12. The educational gaming device for learning evolutionism according to claim 9, wherein said operation unit controls player-character phytophagous creatures or player-character polyphagous creatures to occupy said resource zones so as to increase quantities of said player-character creatures.

13. The educational gaming device for learning evolutionism according to claim 1, wherein when a required quantity parameter of each said player-character creature is satisfied, said operation unit controls said player-character creature to reproduce or summons new species, and wherein mutation occurs randomly during reproduction of said player-character creature.

14. The educational gaming device for learning evolutionism according to claim 1, wherein when said player-character creature moved by said operation unit on said display device is attacked by said non-player-character creature, said operation unit deducts values of survival parameters until said player-character creature or non-player-character creature dies and has zero value of said survival parameter.

15. The educational gaming device for learning evolutionism according to claim 1, wherein said storage device stores parameters and attributes for each representative creature, including a required quantity parameter, a survival parameter, an attack power parameter, a defense power parameter, a movement parameter, a body size parameter, a living environment attribute, an ecological status attribute, a symbiosis attribute, a mutation attribute, and a supplementary attribute, which are presented on said display device by said operation unit.

16. The educational gaming device for learning evolutionism according to claim 15, wherein said living environment attribute refers to land, water or air where one said representative creature lives.

17. The educational gaming device for learning evolutionism according to claim 15, wherein said ecological status attribute refers to phytophagous, polyphagous, or sarcophagous.

18. The educational gaming device for learning evolutionism according to claim 15, wherein said symbiosis attribute refers to interaction of one said representative creature with a practical environment.

19. The educational gaming device for learning evolutionism according to claim 1, wherein said operation unit controls each said representative creature to coexist with another said representative creature or control said representative creatures of an identical species to cluster so as to enhance attack power or defense power thereof.

20. The educational gaming device for learning evolutionism according to claim 1, wherein a bout is defined to be a process that said player-character creature and said non-player-character creature are respectively moved by said operation unit once.

21. The educational gaming device for learning evolutionism according to claim 20, wherein said operation unit increases quantities of said non-player-character creatures with increase of said bout and create responses to locations where said player-character creatures and said non-player-character creatures respectively live.

22. The educational gaming device for learning evolutionism according to claim 20, wherein said operation unit increases natural disasters randomly on said display device with increase of said bout to govern survival of said representative creatures or deduct values of a survival parameter thereof.

23. The educational gaming device for learning evolutionism according to claim 1, wherein said operation unit presents on said display device an operating interface of said player-character creatures, which includes functions of movement, occupation, attack, rest, reproduction, summoning, renourishment and status.

24. The educational gaming device for learning evolutionism according to claim 1, wherein when one said player-character creature dies in said scene, said operation unit controls said player-character creatures surviving to summon decomposers in an environment to decompose a corpse of said player-character creature for renourishment.

25. The educational gaming device for learning evolutionism according to claim 24, wherein said decomposers are bacteria or fungi.
